(19) United States
(12) Patent Application Publication
(10) Pub. No.: US 2026/0166869 A1
(43) Pub. Date: Jun. 18, 2026

(54) MULTI-PHASE PAINT FILM APPLICATION SYSTEM AND PAINT FILM APPLICATION ARRANGEMENT

(71) Applicant: Encore Automation, LLC, Auburn Hills, MI (US)

(72) Inventors: Randall SELK, Shelby Twp., MI (US); Gordon ARNOLD, Clarkston, MI (US); Cameron MOORE, Bloomfield Hills, MI (US); Andrew Gary GAGNE, Clarkston, MI (US); Anthony MAZZOLA, Sterling Heights, MI (US)

(73) Assignee: ENCORE AUTOMATION, LLC, Auburn Hills, MI (US)

(21) Appl. No.: 19/421,566

(22) Filed: Dec. 16, 2025

Related U.S. Application Data
(60) Provisional application No. 63/734,304, filed on Dec. 16, 2024.
(60) Provisional application No. 63/864,052, filed on Aug. 14, 2025.

(51) Int. Cl. B32B 37/02; B32B 37/00; B32B 38/00; B32B 38/18

(52) U.S. Cl. CPC B32B 37/02; B32B 37/0046; B32B 38/0004; B32B 38/185; B32B 2038/1891; B32B 2605/00

(57) ABSTRACT

An automatic film application system for applying a film to a workpiece having a surface. The system includes a roll of film having a finished side and an adhesive side covered with a removable backing. A number of clamps pull a forward end of the roll of film to create an unrolled paint film piece extending over the workpiece. A automated cutting device separates the unrolled paint film piece from the roll of film, while a number of clamps move the unrolled paint film piece into contact with the workpiece. An applicator tool connected to a robot moves across the finished side of the unrolled paint film piece to push air bubbles out from between the workpiece and the adhesive side of the unrolled paint film piece.

### FIELD OF THE INVENTION

The present invention relates to a multi-phase paint film application system that uses automation to prepare, apply and inspect a paint film that has been connected to a treatment surface of a workpiece.

### BACKGROUND OF THE INVENTION

In the automotive field the use of paint films on vehicle body panels, such as roofs, is becoming increasingly more desirable. Compared to traditional painted vehicle panels, paint films have greater chip resistance. Paint films are also more environmentally friendly and reduce the amount of volatile organic compounds released. Additionally, the use of paint films eliminates the need for a manufacturer to have expensive paint line equipment.

The use of paint film does have challenges. In particular applying paint film to large areas of a vehicle such as roofs, hoods and trunk closures can be challenging due to the size and location of the panel. Also paint films have to be applied in an even manner in order to prevent air bubbles from getting trapped between the film and the part surface. Additionally paint films tend to carry static electricity charges when pulled from a roll, which can cause the paint film to cling to unwanted areas.

It is desirable to provide a system that solves all of the above problems, by providing a robotic system that automatically removes paint film from a roll, positions it relative to the part, and then applies the film in an even manner. It is desirable to provide a system that includes components that peel and collect backing layers from the film, eliminate static charges on the surface of the paint film, and have tools for eliminating air bubbles between the paint film and part surface.

### SUMMARY OF THE INVENTION

There are several steps or stages in the multi-phase paint film application system, which in the present example is a system for applying paint film or clearcoat to a workpiece, which in one exemplary embodiment of the invention is a vehicle roof surface. While an automobile is shown it is within the scope of the invention for the workpiece to be any type of component that could benefit from the of paint films, including, but not limited to recreational vehicle bodies, semi-truck cabs, tractors, golf carts, off-road vehicle, snowmobiles, aircrafts, vehicle interior components, construction siding for homes and manufactured housing, boats, helmets, etc.

One aspect of the invention is directed to a multi-phase paint film application system for applying paint film to a treatment surface of a workpiece. The multi-phase system includes a workpiece preparation phase that includes a wetting device configured to apply liquid to different surfaces depending on the needs of a particular application. The wetting device can apply liquid to the treatment surface of the workpiece, a finish surface and/or adherence surface of the paint film. Also, it is within the scope of this invention for the liquid to be applied to the paint film as it rolls out, before squeegeeing, or during squeegeeing. Additionally, it is within the scope of the invention for liquid to be applied to the workpiece as it enters the cell or after. FIG. 1 has the fluid being applied after the film is laid down. The workpiece preparation phase also optionally includes applying heat to either the paint film or the workpiece prior to applying the paint film. This is helpful when the paint film uses a heat activated adhesive. It is also within the scope of this invention for the workpiece preparation phase to include a wetting device for a multi-phase paint film application system that uses a dry adhesive system. A dry system of this type can optionally include a heating step, where the paint film and/or the workpiece is heated.

Once the workpiece preparation phase is completed, the workpiece is moved to a paint film phase. The paint film phase includes an automatic paint film dispenser that has a roll of paint film having a finished surface and an adherence surface, which can be a pre-treated surface with adhesive or a surface that adhesive is applied. The adherence surface is covered by a backing material. Further provided is a backing removal device that removes the backing from an unrolled paint film piece as it is unrolled and stretched off of the roll of paint film. Also, some applications have larger paint film rolls that have a cap sheet that is applied over the finish surface of the paint film. It is also within the scope of this invention for a cap sheet removal device to be provided. Such a device is similar to the backing removal device described herein, with the difference being that the cap sheet removal device has a take up roll positioned above the finish surface of the roll of paint film.

The paint film phase includes a paint film application arrangement that includes several components, including an automated cutting device configured to separate the unrolled paint film piece from the roll of paint film. The automated cutting device is a moving razor blade connected to a carrier on a track. It is also possible for the automated cutting device to be a laser or sonic knife.

The paint film application arrangement further includes a plurality of clamps for grasping, stretching and holding the unrolled paint film piece during the operation of the cutting device. The plurality of clamps also hold the unrolled paint film sheet at a distance from the treatment surface of the at least one workpiece, wherein once the unrolled paint film piece has been separated from the roll of paint film the plurality of clamps move the adherence surface of the unrolled paint film piece into contact with the treatment surface of the workpiece. Next a robot having a squeegee tool engages and moves the squeegee tool across the finished surface with a plurality of strokes until a desired portion of the finished surface has been squeegeed, which removes air bubbles and causes the adherence surface of the paint film to bond with the treatment surface.

The workpiece preparation phase optionally includes a defect detection and cleaning steps for the workpiece. Defect detection can be accomplished using cameras, or other sensors to view the surface of the workpiece to detect surface aberrations, which can be accomplished using automated vision systems. Additionally, this step can include automatic defect repair systems, which is sometimes referred to as automatic finessing of the surface of the workpiece.

The paint film preparation and dispensing phase also includes an optional cleaning step that includes applying a cleaner to the surface of the workpiece, which is sometimes needed prior to application of a paint film. After removal of the backing material, and optionally the cap layer for larger paint film rolls, the next step involves a cutting stage where a piece of unrolled material is cut off of the roll, then an apply sequence step occurs where a combination of film holding elements or clamps sequentially apply the paint film to the workpiece in a desired manner. This accurate positioning the paint film piece helps to reduce paint film waste. Optionally prior to the application step a liquid solution can be applied to the surface of the workpiece. In one embodiment, once the unrolled paint film piece is applied to the surface of the workpiece a wetting step occurs wherein a liquid solution is applied to the finished side of the paint film. However, this wetting step is optional and is not necessary for all embodiments. Next an auto squeegee step takes place where a robot with a squeegee applies a plurality of strokes across the finished surface of the film, to activate the adhesive of the paint film piece and to push bubbles out from between the paint film and the surface of the workpiece. The squeegee in on embodiment is a standard squeegee, however it is possibly to use other tools such as a rib squeegee tool, a blade or possibly a liquid sprayer. Lastly, a trimming step occurs where a robot with a laser, sonic knife, or other suitable cutting tool suitable for trimming the edges of the paint film to make a complete part and ready for an inspection step that can be performed using automatic vision or manual inspection. The trimming step also includes automatically or manually removing or peeling the scrap film from the workpiece after the trimming is complete. Next, prior to the inspection step, the processes will require automatic or manual squeegeeing after the film is cut to do a final tuck on the edges of the paint film piece.

Another aspect of the invention is directed to an automatic film application system for applying a film to a workpiece having a surface. A roll of film having a finished side and an adhesive side covered with a removable backing, wherein a portion of the roll of film is selectively unrolled to form an unrolled paint film piece. An automatic film dispenser having a rotatable material holder for holding the roll of film and selectively unrolling the portion of the roll of film to form the unrolled paint film piece having a finished side and an adhesive side. In the present embodiment a waste holder is shown connected to the removable backing for collecting the removable backing from the unrolled paint film piece. While the waste holder is shown connected to the backing, this is optional, and it is within the scope of this invention for the waste holder to have other configurations not connected to the backing. For example, if the stock of film is sized pre-cut sheets the backing and cap sheet (if present) would be removed and placed into a waste holder without the waste holder being connected to the backing. In such an embodiment the waste holder could be a bin positioned to receive the removed backing material. The robot tooling would hold the sheet in position while the machine clamps grabbed the film from the robot.

In the present embodiment of the invention an ion generator projects ionic particles onto the adhesive side of the unrolled paint film piece when the removable backing is removed to neutralize a static charge on the adhesive side of the roll of film. A automated cutting device selectively movable across the unrolled paint film piece to separate the unrolled paint film piece from the roll of film.

At least one forward end clamp, wherein a forward end of the roll of film is held by the at least one forward end clamp and is moveable between a first longitudinal position and a second longitudinal position to form the unrolled paint film piece, the unrolled paint film piece is extended over the workpiece. At least one left side clamp configured to releasably hold a portion of the left side of the unrolled paint film piece as the automated cutting device cuts separates the unrolled paint film piece from the roll of film, wherein the unrolled paint film piece is extended over the workpiece and the at least one left side clamp is selectively moveable from a first vertical position above the workpiece, to a second vertical position below the first vertical position.

At least one right side clamp configured to releasably hold a portion of the left side of the unrolled paint film piece as the automated cutting device cuts separates the unrolled paint film piece from the roll of film, wherein the unrolled paint film piece is extended over the workpiece and the at least one right side clamp is selectively moveable from a first vertical position above the workpiece, to a second vertical position below the first vertical position. The system further includes an applicator tool connected to the end of a robot, the applicator tool having a squeegee that contacts a finished side of the unrolled paint film piece, wherein the robot applies pressure to the finished side of the unrolled paint film piece and the squeegee is moved across the surface of the finished side of the unrolled paint film piece to push one or more air bubbles out of a location between an adhesive side of the unrolled paint film piece and the surface of the workpiece.

### BRIEF DESCRIPTION OF THE DRAWINGS

FIG. 1 is a flow diagram depicting a multi-phase paint film application system according to one embodiment of the present invention.

FIG. 2 a schematic view of the forward end clamps of the multi-phase paint film application system.

FIG. 3 is a schematic side perspective view of the forward end clamps in position near the automatic paint film dispenser.

FIG. 4 is a schematic side perspective view of the forward end clamps pulling the paint film from the automatic paint film dispenser.

FIG. 5 is a schematic bottom perspective view of the automatic paint film dispenser.

FIG. 6 is a schematic top plan view of the unrolled paint film piece held over the workpiece by the plurality of clamps.

FIG. 7 is a schematic top perspective view of the right rear corner of the unroll paint film piece being cut by the automated cutting device.

FIG. 8 is a schematic side elevational view of the unrolled paint film piece being applied to the treatment surface of the workpiece by the plurality of clamps.

FIG. 9A is a schematic top perspective view of the front corner and the left side corner clamp.

FIG. 9B is a schematic top perspective view of the front corner and the right side corner clamp.

FIG. 10 is a schematic top perspective view of the squeegee tool applying the unrolled paint film piece to the treatment surface of a workpiece.

FIG. 11 is a first side perspective view of a robotic arm having a squeegee tool according to one aspect of the invention.

FIG. 12 is a second side perspective view of a robotic arm having a squeegee tool according to one aspect of the invention.

FIG. 13 is an enlarged side view of the first side of the robotic arm.

FIG. 14 is a side end view of an alternate squeegee tool.

FIG. 15 is an end view of the primary blade of the alternate squeegee tool.

FIG. 16 is a schematic side perspective view the forward left side corner clamp.

FIG. 17 is a schematic side perspective view of the rear left side corner clamp.

### DETAILED DESCRIPTION OF THE PREFERRED EMBODIMENTS

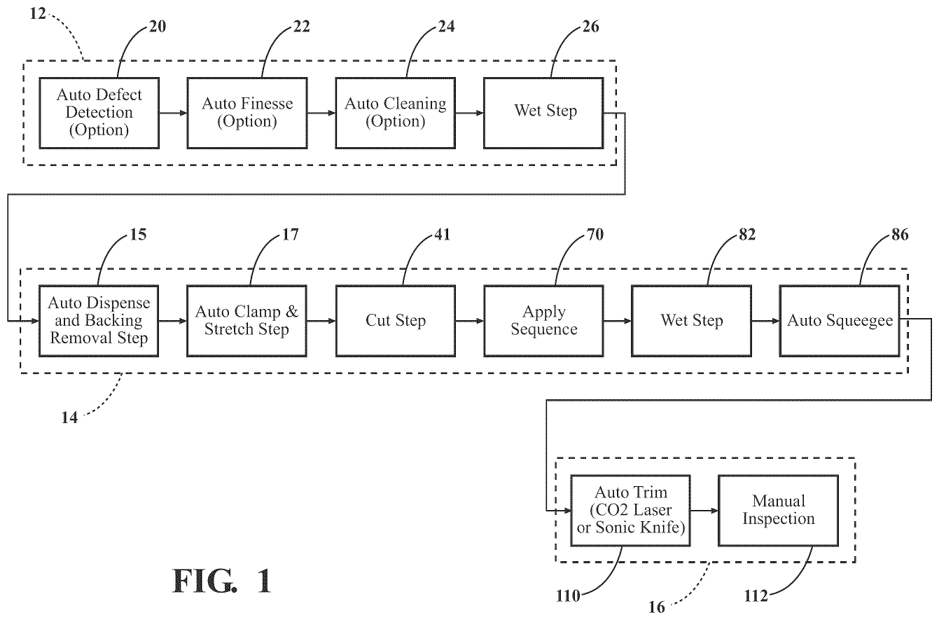

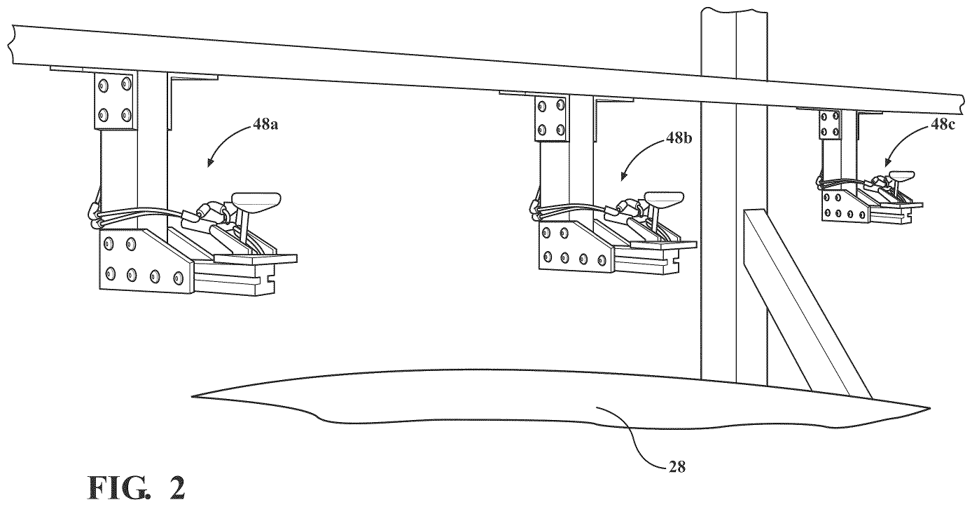

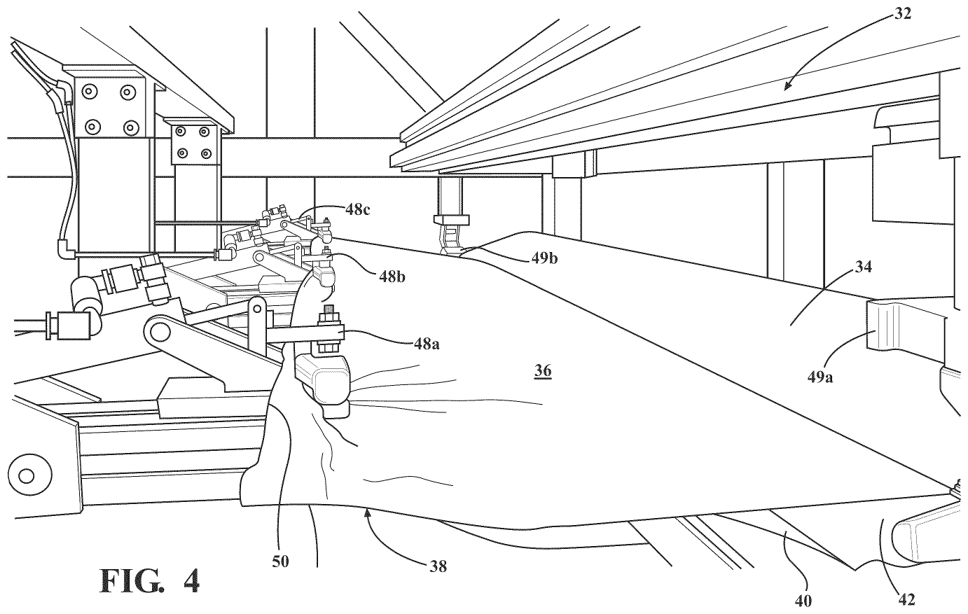

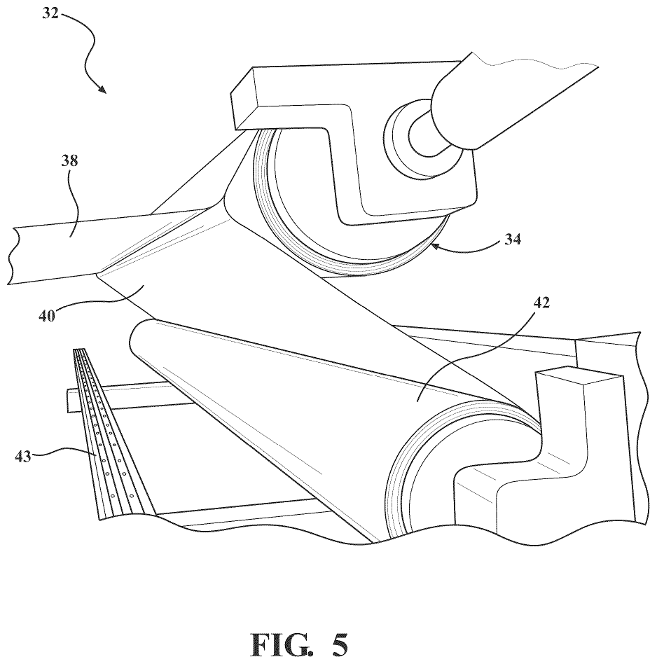

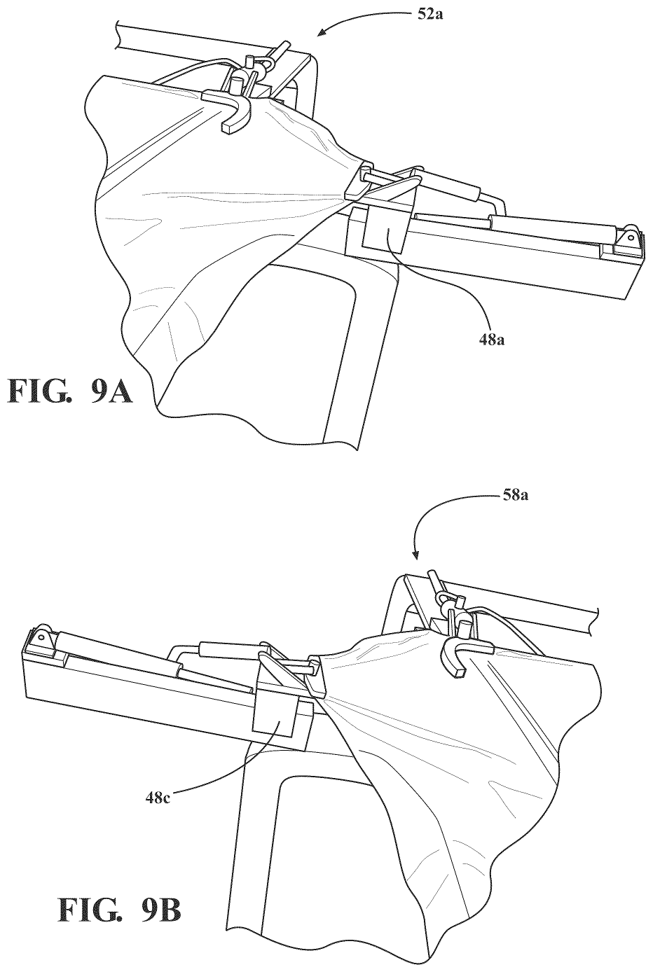

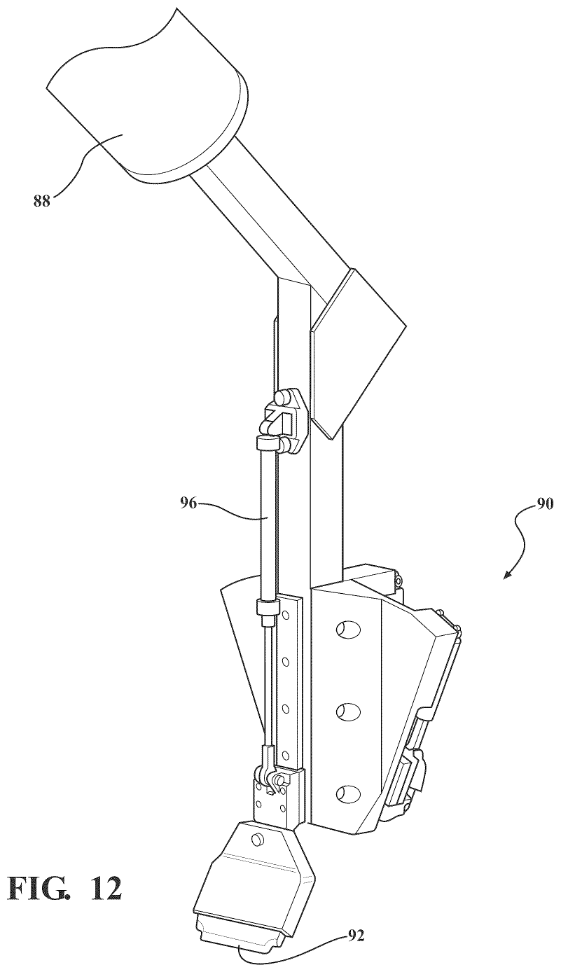

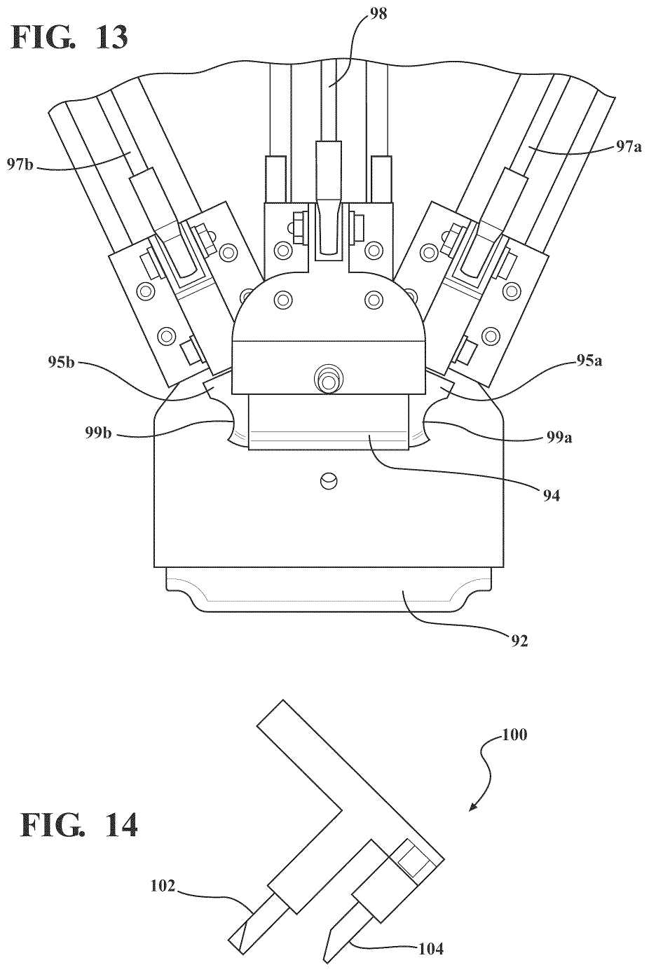

Terms “robot” or “robotic arm” appearing below refers to any type of robot including, but not limited to an articulated arm, humanoid robot, drone and other mechanical structure robots including Cartesian, selective compliance assembly (SCARA), delta or collaborative robots. FIG. 1 depicts a flow diagram of an overall process of a multi-phase paint film application system 10 having various phases, while FIGS. 2-17 show more specific details and devices used as part of the multi-phase paint film application system 10. The multi-phase paint film application system 10 depicted in FIG. 1 has three general phases including a workpiece preparation phase 12, a paint film phase 14 and an trim and inspection phase 16. A workpiece 18, shown in FIGS. 2-10 is moved through each of the phases of the system 10 using an automated track or conveyor to move the workpiece 18 physically through the system 10. Alternatively, the workpiece can be located at a stationary position while the devices of each phase of the system 10 move about the workpiece 18.

The workpiece preparation phase 12 includes an auto defect detection step 20 where the surfaces of the workpiece 18 are inspected for any defects using cameras, lasers, soundwaves, touch or other sensors. Defects detected during the auto defect detection step 20 include but are not limited to scratches, dents or other surface aberrations. Then during an auto finesse step 22 a robot with one or more tools are used to correct the detected defect. The one or more tools can include sanding, polishing or wiping wheels, as well as nozzles or applicators that apply buffing, polishing or other defect correction products. The auto defect detection step 20 and auto finesse step 22 include systems and tools described in U.S. Pat. No. 11,310,467 B2 titled “Object inspection system and method of inspecting an object” issued on Apr. 19, 2022; and U.S. Pat. No. 11,937,020 B2 titled “Object inspection system and method for inspecting an object” issued on Mar. 29, 2024, the entire disclosures of these patents are hereby incorporated by reference in their entirety. Next an auto cleaning step 24 occurs, wherein a robot with one or more tools clean the desired surfaces of the workpiece 18. The robot can be the same robot used in the auto finesse step 22, but with a different tool, or a completely different robot is used. During the auto cleaning step 24 the robot cleans desired surfaces of the workpiece 18 with a tool that has a brush, wiping pad and can also include nozzles or applicators for applying a wash solution to the surface of the workpiece 18. The next step is a wet step 26, where a liquid or gel material is applied to a treatment surface 28 of the workpiece 18. In one preferred embodiment the gel material is used has water, alcohol and a surfactant. The wet step 26 is accomplished using a wetting device, which is a spray nozzle attached to a robot, a spray halo or a roller connected to a robot, wherein liquid is sprayed onto the roller from a nozzle on the robot. The treatment surface 28 is the surface of the workpiece 18 that an unrolled paint film piece 30 is applied to.

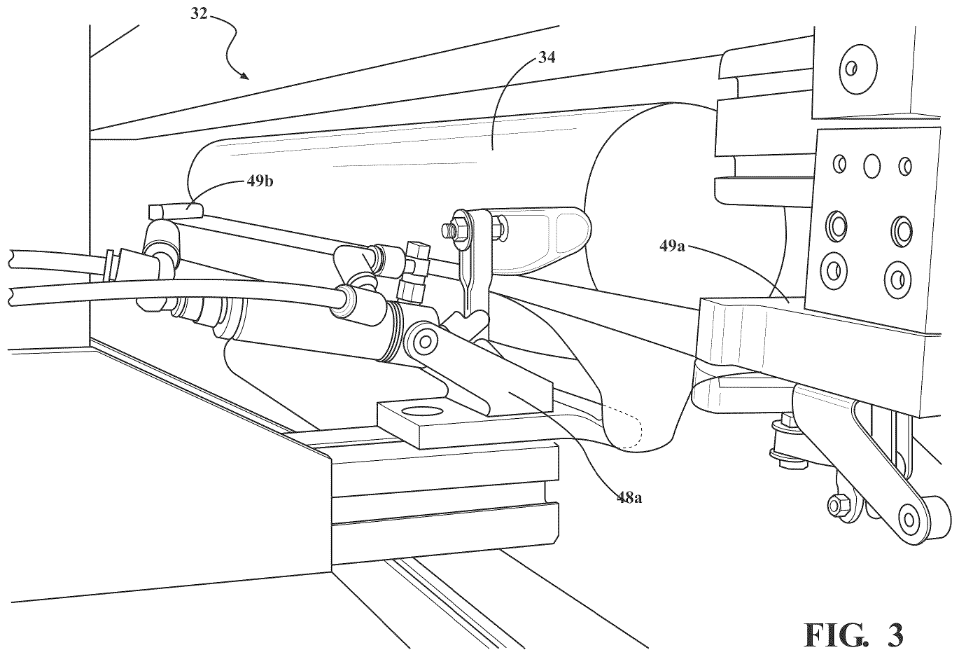

After the workpiece preparation phase 12 is complete the workpiece 18 is moved to a paint film phase 14. FIGS. 2-5 show details of the paint film phase 14 and includes a roll of paint film 34 that is unrolled to create the unrolled paint film piece 30 that is then separated from the roll of paint film 34. The paint film phase 14 further includes an automatic paint film dispenser 32 that performs auto dispense and backing removal step 15 using an auto clamp and stretch step 17. As shown in FIGS. 3-5, the roll of paint film 34 is connected to a motorized drum that rotates to unroll the paint film. The paint film that is on the roll of paint film 34, and unrolled paint film piece 30 both have a finished surface 36 and an adherence surface 38, which can be a pre-treated surface with adhesive or a surface upon which an adhesive is applied. The paint film on the roll of paint film 34 has a backing material 40 covering the adherence surface 38 so it will not stick on the roll. During the auto dispense and backing removal step 15, a backing removal device 42 removes the backing 40 from the unrolled paint film piece 30 as it is unrolled from the roll of paint film 34. The backing removal device 42 is a motorized drum positioned below the roll of paint film 34 and is connected to a forward end of the backing material 40. The motorized drum rotates as the unrolled paint film piece 30 is pulled off of the roll of paint film 34 and collects the backing material 40. Also, some applications have larger paint film rolls that have a cap sheet that is applied over the finish surface of the paint film. It is also within the scope of this invention for a cap sheet removal device to be provided. Such a device is similar to the backing removal device described herein, with the difference being that the cap sheet removal device has a take up roll positioned above the finish surface of the roll of paint film.

The paint film phase 14 also further includes a de-ionization device 43 configured to apply a de-ionization stream of positive and negatively charged particles onto the adherence surface 38 of the unrolled paint film piece 30. This helps to mitigate static charges on the adherence surface to prevent unwanted clinging or attraction of the adherence surface 38 to the treatment surface 28 until the unrolled paint film piece 30 is in a desired position.

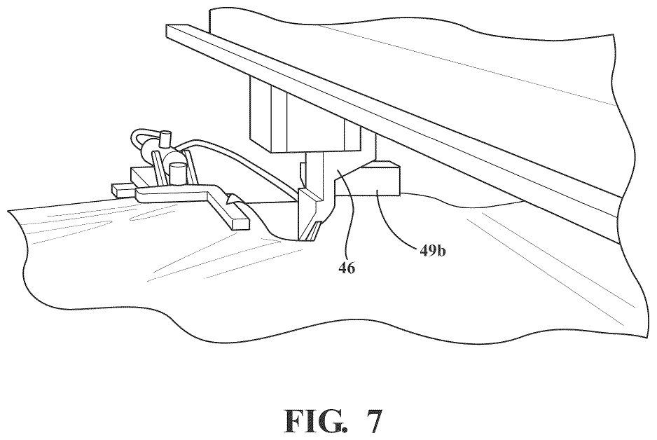

The paint film phase 14 further includes a paint film application arrangement 44 having several components. The paint film application arrangement 44 includes an automated cutting device 46 configured to carry out a cut step 41 and separate the unrolled paint film piece 30 from the roll of paint film 34 as partially shown in FIG. 7. The automated cutting device 46 is a moving razor blade connected to a carrier on a track. It is also possible for the automated cutting device 46 to be a laser or sonic knife connected to a carrier on a track. It is further within the scope of this invention for a robot to be used instead of a carrier and track.

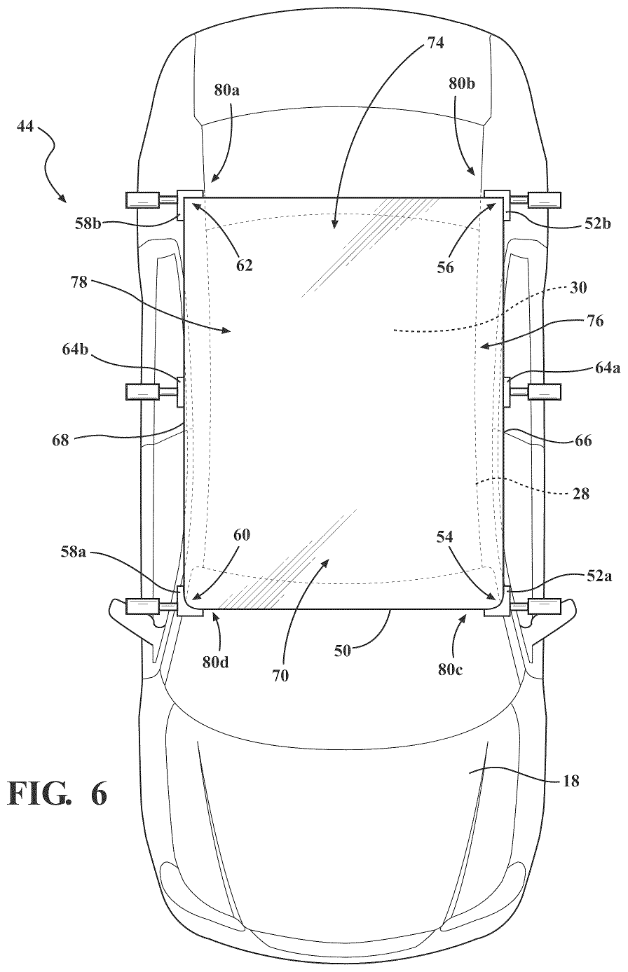

Referring now to FIG. 6, the paint film application arrangement 44 further includes a plurality of clamps that perform the auto clamp and stretch step 17, where the unrolled paint film piece 30 is unrolled from the roll of paint film 34, stretched over the workpiece 18, and held during the cut step 41. While a certain number, location and configuration of the plurality of clamps is shown, it is within the scope of this invention for there to be a greater or lesser number, different locations or configurations depending on the needs of a particular application. For example, a larger unrolled paint film piece can require more clamps, while a smaller piece will require fewer clamps. An irregular shaped paint film piece could require clamps with different configurations or different locational positions.

Included in the plurality of clamps are two roll end clamps 49a, 49b that hold an end of the paint film that is connected to the roll of paint film 34 once the unrolled film piece 30 has been separated. The two supply end clamps 49a, 49b grasp and hold the unrolled paint film piece 30 during the operation of the automated cutting device 46, which is partially shown in FIG. 7.

The plurality of clamps include forward end clamps 48a, 48b, 48c, wherein a forward end 50 of the roll of paint film 34 is held by the forward end clamps 48a, 48b, 48c and is moveable between a first longitudinal position and a second longitudinal position to pull and the unrolled paint film piece 30 and extend the unrolled paint film 30 piece over the treatment surface 28 of the workpiece 18.

The plurality of clamps further include a pair of left side corner clamps 52a, 52b, where left side corner clamp 52a is located at a front corner 54 of the unrolled paint film piece 30 and left side corner clamp 52b is located at a rear corner 56 of the unrolled paint film piece 30. The left side corner clamps 52a, 52b are configured to releasably hold a portion of a left side of the unrolled paint film piece 30 as the automated cutting device 46 cuts and separates the unrolled paint film piece 30 from the roll of paint film 34. The unrolled paint film piece 30 is extended over the treatment surface 28 of the workpiece 18 and pair of left side corner clamps 52a, 52b are selectively moveable from a first vertical position above the workpiece 18, to a second vertical position below the first vertical position, to move the adherence surface 38 of the unrolled paint film piece 30 into contact with the treatment surface 28 of the workpiece 18.

The plurality of clamps further include a pair of right side corner clamps 58a, 58b. Right side corner clamp 58a is located at a front corner 60 of the unrolled paint film piece 30, and the pair of right side corner clamp 58b is located at a rear corner 62 of the unrolled paint film piece 30. The pair of right side corner clamps 58a, 58b are configured to releasably hold a portion of a right side of the unrolled paint film piece 30 as the automated cutting device 46 cuts and separates the unrolled paint film piece 30 from the roll of paint film 34. The unrolled paint film piece 30 is extended over the treatment surface 28 of the workpiece 18 and the pair of right side corner clamps 58a, 58b are selectively moveable from a first vertical position above the workpiece 18, to a second vertical position below the first vertical position, to move the adherence surface 38 of the unrolled paint film piece 30 into contact with the treatment surface 28 of the workpiece 18.

As shown in FIG. 6, there is a left side edge clamp 64a that grasps a portion of a left side edge 66 of the unrolled paint film piece 30, and a right side edge clamp 64b that grasps a portion of the right side edge 68 of the unrolled paint film piece 30. The left side edge clamp 64a and the right side edge clamp 64b contribute to the auto clamp and stretch step 17 by stretching and supporting the respective left side edge 66 and right side edge 68 of the unrolled paint film piece 30. Also, the left side edge clamp 64a and right side edge clamp 64b function to assist in the apply sequence mention below, by lowering the adherence surface 38 of the unrolled paint film piece 30 onto the treatment surface 28. While a single left side edge clamp 64a and right side edge clamp 64b are shown, it is within the scope of the invention for there to be a greater number of left and right side edge clamps depending on several factors including the length and shape of the unrolled film piece.

During the auto clamp and stretch step 17, and cutting step 41 of paint film phase 14, forward end clamps 48a, 48b, 48c grasp the forward end 50 of the unrolled paint film piece and pull the forward end 50 away from the automatic paint film dispenser 32, to extend the unrolled paint film piece 30 over the treatment surface 28 of the workpiece 18. Next, the left side corner clamp 52b and right side corner clamp 58b each grasp the unrolled paint film piece 30 at what will be the respective rear corners 56, 62 of the unrolled paint film piece 30 when it is separated from the roll of paint film 34. The two roll end clamp film 9b grasp the end of the paint film that will still be connected to the roll of paint film 34 after operation of the automated cutting device 46 during the cut step 41. The automated cutting device 46 cuts and separate the unrolled paint film piece 30 from the roll of paint film 34 by passing between the left side corner clamp 52b, right side corner clamp 58b and two roll end clamps 49a, 49b to separate the unrolled paint film piece 30.

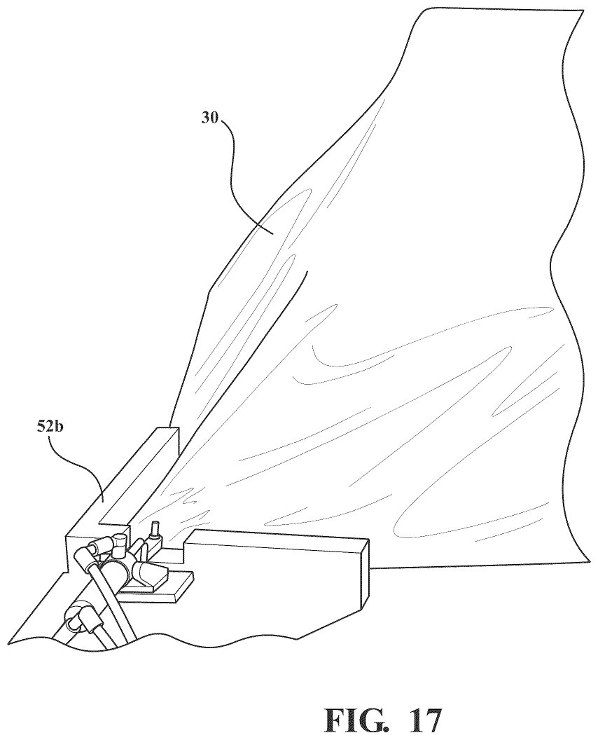

The left side corner clamps 52a, 52b and the right side corner clamps 58a, 58b grasp around the corners of the respective unrolled paint film piece 30. Referring now to FIGS. 6, 16 and 17, in one embodiment left side corner clamp 52a and right side corner clamp 58a have a curved shape and are contoured to the arc of the roof (i.e., workpiece 18) that the unrolled paint film piece 30 is being applied to. FIG. 16 shows the detail of the left side corner clamp 52a, and it is understood that the right side corner clamp 58a has a similar shape or configuration. The curved shape of left side corner clamp 52a and right side corner clamp 58a allow for the left corner 54 and right corner 60 to be pulled down over the edge of the treatment surface 28 without any sharp angles (e.g. 90 degree edge clamps), in a manner that minimizes tearing or wrinkling. In this particular embodiment the left side corner clamp 52b and right side corner clamp 58b are not arcuate but extend 90 degrees and 8 inches in each direction because the shape of the treatment surface 28 benefits from a 90 degree shaped. FIG. 17 shows details of the left side corner clamp 52b and it is understood that the right side corner clamp 58b has a similar shape and configuration. It is within the scope of this invention for the left side corner clamps 52a, 52b and the right side corner clamps 58a, 58b to all be curved in shape or to have a right angle shape depending on the need of a particular application.

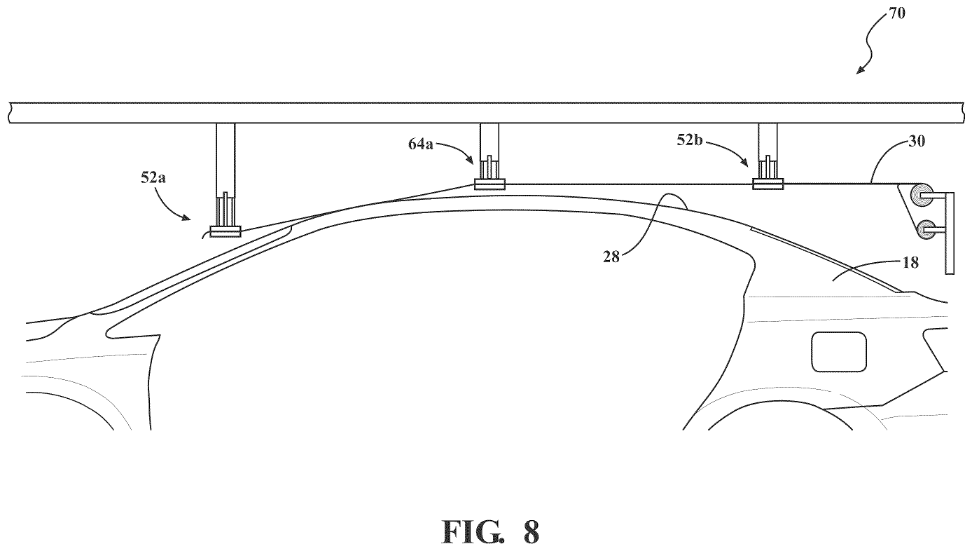

FIGS. 6 and 8 show the details of an apply sequence 70 of the paint film phase 14. During the apply sequence 70, the forward end clamps 48a, 48b, 48c release the forward end 50 of the unrolled paint film piece 30. The left side corner clamps 52a, 52b, right side corner clamps 58a, 58b, left side edge clamp 64a, and right side edge clamp 64b move vertically to bring the adherence surface 38 of the unrolled paint film piece 30 into contact with the treatment surface 28 of the workpiece 18. Each individual clamp of the plurality of clamps are independently longitudinally, vertically and horizontally moveable, which allows for the applying sequence to be customized or adjusted depending on the shape or size of the treatment surface 28, which allows for the minimization of air bubbles between the treatment surface 28 and the adherence surface 38. FIGS. 6 and 8 show one example where it has been determined that a particular treatment surface 28 is more susceptible to having air bubbles at a forward region 72 of the unrolled paint film piece 30. The applying sequence 70 can be adjusted so that the left side corner clamp 52a and right side corner clamp 58a move vertically downward at a faster rate so that adherence surface 38 in the forward region 72 of the unrolled paint film piece 30 contacts the treatment surface 28 first, thereby causing air bubbles to migrate out of the front region 72 before the rest of the adherence surface 38 makes contact. This is just one example of how the applying sequence 70 can be adjusted and it is within the scope of the invention for the vertical movement of the plurality of clamps to be varied so that other regions, like a rearward region 74, left region 76, right region 78 or the corner regions 80a, 80b, 80c, 80d of the adherence surface 38 make contact first. The terms forward, rearward left and right are all relative terms that refer to the areas of the unrolled paint film piece 30 as shown in the drawings and is not limiting to any specific side of a workpiece. For example, a forward portion of a vehicle roof could be located where the rearward region 74 of the unrolled paint film piece 30 is applied, or it could be vice-versa depending on the particular application.

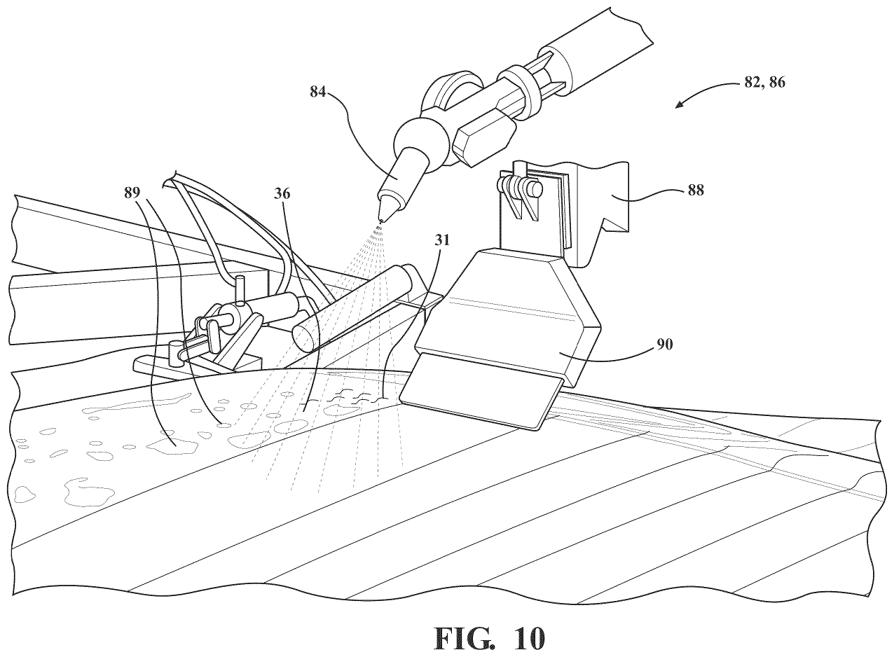

Referring to FIG. 10, after the applying sequence 70 occurs, a wet step 82 takes place, wherein a finished surface spraying device 84 sprays the finished surface 36 of the unrolled paint film piece 30 with a liquid 31. The liquid is typically a soapy water solution or other suitable liquid. The finish surface spraying device 84 as shown is a robotic arm with a spray nozzle that has finished spraying the liquid 31 on the finished surface 36. However, liquid can be applied with other devices such as a water halo or manually using a spray bottle. Next an auto squeegee 86 step occurs, wherein a robot 88 with a squeegee tool 90 engages and moves the squeegee tool 90 across the finished surface 36 with a plurality of strokes until a desired portion of the finished surface 36 has been squeegeed. During this process liquid (not shown) and air bubbles 89 between the adherence surface 38 of the unrolled paint film piece 30 and the treatment surface 28 of the workpiece 18 are pushed out and removed so that the unrolled paint film piece 30 adheres to the treatment surface 28. The liquid 31 applied to the finished surface 36 is a solution having a surfactant that reduces friction between the squeegee tool 90 and the finished surface 36 to prevent damage to the finished surface 36. In one embodiment the liquid is a mild soap and water solution, however, any solution that sufficiently reduces friction can be used.

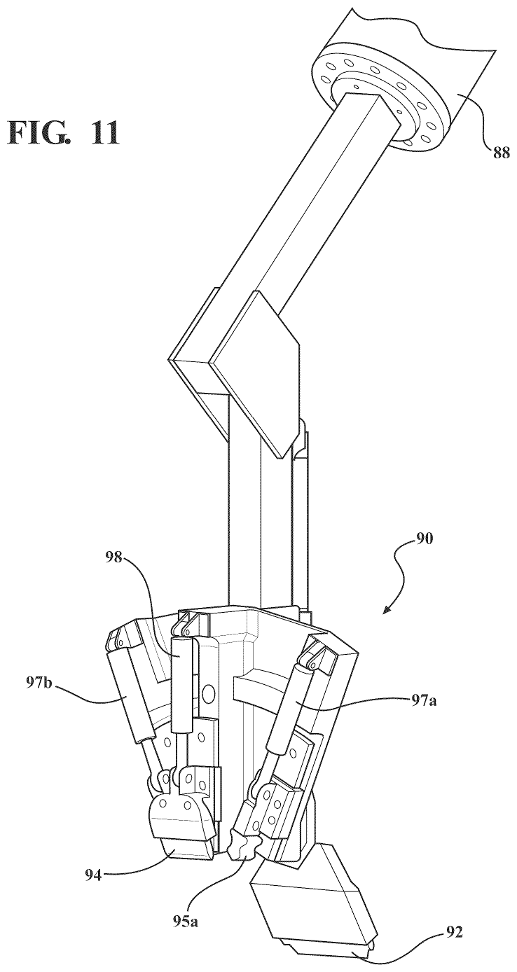

FIGS. 11-13 show the details of the squeegee tool 90 connected to the robot 88. In one embodiment of the invention the squeegee tool 90 is a multi-faceted squeegee tool having two flexible blades that include a primary blade 92 and a secondary blade 94 each individually moveable between extended and retracted positions by respective linear actuators 96, 98. FIGS. 11-13 also show a squeegee tool 90 that further include a left edge blade 95a and a right edge blade 95b each moveable between extended and retracted positions by a respective linear actuator 97a, 97b. The left edge blade 95a and right edge blade 95b are smaller squeegee blades each having a respective concave edge 99a, 99b that is curved to allow the contact edge some flexibility as the left edge blade 95a and right edge blade 95b each press the unrolled paint film piece 30 onto ribs or raised features on the treatment surface 28.

One issue that can occur with using paint film on the parts is that a defect referred to as adhesion tear can develop as a result of the squeegee moving across the finished surface 36. This is problematic because it cannot be corrected unless the film is removed and re-applied. In order to address adhesion, tear the primary blade 92 is a first stage that uses a soft squeegee to press the material in place, followed by the secondary blade 94, which is a harder squeegee used to activate the adhesive.

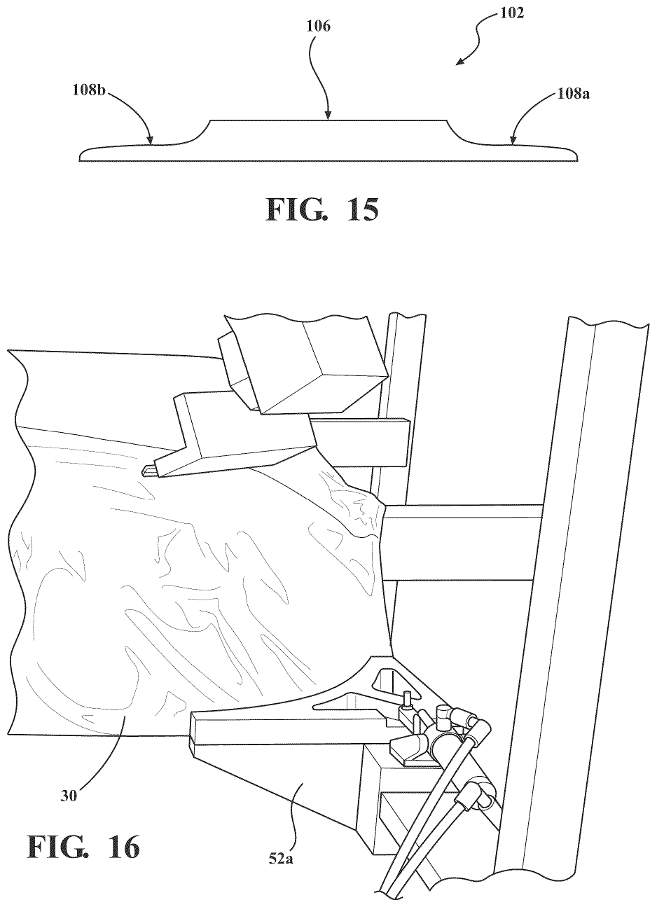

FIGS. 14 and 15 depicts an alternate squeegee tool 100 to address the adhesion tear issues that can develop. This alternate squeegee tool 100 has a tapered blade 102 and a secondary blade 104 located above the tapered blade 102. FIG. 15 shows an edge view of a tapered blade 100 that can be used in place of primary blade 92, secondary blade 94 or the secondary blade 104 described above. The tapered blade 102 has a thicker in a middle region 106 and two end regions 108a, 108b that are at opposite adjacent sides of the middle region 106. The two end regions 108a, 108b are thinner. The combination of the middle region 106 and two end regions 108a, 108b create a variable flex across the contact surface of the tapered blade 102, which minimizes the adhesion tear problem mentioned above. Also, in another optional application of the invention the tapered blade 102 and secondary blade 104 are formed of felt or have a felt covering over the edge of the blade, which also helps to eliminate adhesion tear. In yet another aspect of the invention the liquid 31 eliminates adhesion tear by eliminating friction.

After the auto squeegee 86 step the workpiece 18 is moved to the trim and inspection phase 16. During an auto trim 110 step the excess paint film material of the unrolled paint film piece 30 that is not attached to the treatment surface 28 is removed. This removal is accomplished using a robot which trims off the excess material using a cutting device. It is also within the scope of this invention for this step to be handled manually. Once the excess material is removed an inspection 112 step occurs, where the adhered paint film is examined to determine if there are any quality issues. This can be accomplished using cameras or sensors that detect defects. The cameras can be mounted at a stationary location along the system line, or they can be mounted to a robot that moves about the workpiece. It is also within the scope of the invention for the inspection to be done manually.

What is claimed is:

1. A multi-phase paint film application system comprising:
a workpiece having a treatment surface;
a workpiece preparation phase that includes a wetting device configured to apply liquid to the treatment surface of the workpiece;
a paint film phase that includes an automatic paint film dispenser that has a roll of paint film having a finished surface and an adherence surface that is covered by a backing material and a backing removal device that removes the backing from an unrolled paint film piece as it is unrolled from the roll of paint film, and
a paint film phase including a paint film application arrangement comprising:
an automated cutting device configured to separate the unrolled paint film piece from the roll of paint film,
a plurality of clamps for grasping and holding the unrolled paint film piece during the operation of the automated cutting device, the plurality of clamps also hold the unrolled paint film sheet at a distance from the treatment surface of the at least one workpiece, wherein once the unrolled paint film piece has been separated from the roll of paint film the plurality of clamps move the adherence surface of the unrolled paint film piece into contact with the treatment surface of the workpiece,
a finished surface spraying device sprays the finished surface of the unrolled paint film piece with liquid,
a robot having a squeegee tool engages and moves the squeegee tool across the finished surface with a plurality of strokes until a desired portion of the finished surface has been squeegeed.

2. The multi-phase paint film application system of claim 1, wherein the liquid applied by the wetting device of the workpiece preparation phase is a gel material having water, alcohol and a surfactant.

3. The multi-phase paint film application system of claim 1, wherein the wetting device of the workpiece preparation phase is a roller connected to a robot, wherein liquid is sprayed onto the roller from a nozzle on the robot.

4. The multi-phase paint film application system of claim 1, wherein the paint film phase includes a de-ionization device configured to apply a de-ionization stream of positive and negatively charged particles onto the adherence surface of the unrolled paint film piece.

5. The multi-phase paint film application system of claim 1, wherein the plurality of clamps further include:
at least one forward end clamp, wherein a forward end of the roll of film is held by the at least one forward end clamp and is moveable between a first longitudinal position and a second longitudinal position to form the unrolled paint film piece and extend the unrolled paint film piece over the treatment surface of the workpiece, wherein the at least one forward end clamp is moveable between a first vertical position above the workpiece, to a second vertical position below the first vertical position to move the adherence surface of the unrolled paint film piece into contact with the treatment surface of the workpiece;
at least one left side clamp configured to releasably hold a portion of a left side of the unrolled paint film piece as the automated cutting device cuts separates the unrolled paint film piece from the roll of film, wherein the unrolled paint film piece is extended over the treatment surface of the workpiece and the at least one left side clamp is selectively moveable from a first vertical position above the workpiece, to a second vertical position below the first vertical position to move the adherence surface of the unrolled paint film piece into contact with the treatment surface of the workpiece, and
at least one right side clamp configured to releasably hold a portion of a right side of the unrolled paint film piece as the automated cutting device cuts separates the unrolled paint film piece from the roll of film, wherein the unrolled paint film piece is extended over the workpiece and the at least one right side clamp is selectively moveable from a first vertical position above the workpiece, to a second vertical position below the first vertical position.

6. The multi-phase paint film application system of claim 1, wherein the plurality of clamps further include:
at least one forward end clamp, wherein a forward end of the roll of film is held by the at least one forward end clamp and is moveable between a first longitudinal position and a second longitudinal position to form the unrolled paint film piece and extend the unrolled paint film piece over the treatment surface of the workpiece, wherein the at least one forward end clamp is moveable between a first vertical position above the workpiece, to a second vertical position below the first vertical position to move the adherence surface of the unrolled paint film piece into contact with the treatment surface of the workpiece;
a pair of left side corner clamps, wherein a first one of the pair of left side corner clamps is located at a front corner of the unrolled paint film piece and a second one of the pair of left side corner clamps is located at a rear corner of the unrolled paint film piece, wherein the pair of left side corner clamps are configured to releasably hold a portion of a left side of the unrolled paint film piece as the automated cutting device cuts separates the unrolled paint film piece from the roll of film, wherein the unrolled paint film piece is extended over the treatment surface of the workpiece and pair of left side corner clamps are selectively moveable from a first vertical position above the workpiece, to a second vertical position below the first vertical position to move the adherence surface of the unrolled paint film piece into contact with the treatment surface of the workpiece, and
a pair of right side corner clamps, wherein a first one of the pair of right side corner clamps is located at a front corner of the unrolled paint film piece and a second one of the pair of right side corner clamps is located at a rear corner of the unrolled paint film piece, wherein the pair of right side corner clamps are configured to releasably hold a portion of a right side of the unrolled paint film piece as the automated cutting device cuts separates the unrolled paint film piece from the roll of film, wherein the unrolled paint film piece is extended over the treatment surface of the workpiece and pair of right side corner clamps are selectively moveable from a first vertical position above the workpiece, to a second vertical position below the first vertical position to move the adherence surface of the unrolled paint film piece into contact with the treatment surface of the workpiece.

7. The multi-phase paint film application system of claim 1, wherein the finished surface spray devices sprays the finished surface of the unrolled paint film piece with liquid using a spray nozzle connected to the robot adjacent the squeegee.

8. The multi-phase paint film application system of claim 1, wherein the paint film application arrangement sprays finished surface of the unrolled paint film piece using a spray halo where the workpiece with the unrolled paint film piece is moved through the spray halo and the liquid is applied to the finished surface.

9. The multi-phase paint film application system of claim 1, wherein the squeegee has an edge with two opposing flexible ends with a stiff portion between the two flexible ends.

10. The multi-phase paint film application system of claim 1 further comprising a trim and inspection phase wherein a robotic arm with a trimming tool removes any excess unrolled paint film material from the finished surface and cameras mounted to a robot are used to inspect the finished surface of the paint film piece on the workpiece to determine if there are any defects.

11. The multi-phase paint film application system of claim 1, wherein the wetting device of the workpiece preparation phase is a spray halo where the workpiece is moved through the spray halo and the liquid is applied to the treatment surface of the workpiece.

12. A multi-phase paint film application system comprising:
a workpiece having a treatment surface;
a workpiece preparation phase that includes a wetting device configured to apply liquid to the treatment surface of the workpiece;
a paint film phase that includes an automatic paint film dispenser that has a roll of paint film having a finished surface and an adherence surface that is covered by a backing material and a backing removal device that removes the backing from an unrolled paint film piece as it is unrolled from the roll of paint film, wherein the paint film phase includes a de-ionization device configured to apply a de-ionization stream of positive and negatively charged particles onto the adherence surface of the unrolled paint film piece, and
a paint film phase including a paint film application arrangement comprising:
an automated cutting device configured to separate the unrolled paint film piece from the roll of paint film,
at least one forward end clamp, wherein a forward end of the roll of film is held by the at least one forward end clamp and is moveable between a first longitudinal position and a second longitudinal position to form the unrolled paint film piece and extend the unrolled paint film piece over the treatment surface of the workpiece, wherein the at least one forward end clamp is moveable between a first vertical position above the workpiece, to a second vertical position below the first vertical position to move the adherence surface of the unrolled paint film piece into contact with the treatment surface of the workpiece,
a pair of left side corner clamps, wherein a first one of the pair of left side corner clamps is located at a front corner of the unrolled paint film piece and a second one of the pair of left side corner clamps is located at a rear corner of the unrolled paint film piece, wherein the pair of left side corner clamps are configured to releasably hold a portion of a left side of the unrolled paint film piece as the automated cutting device cuts separates the unrolled paint film piece from the roll of film, wherein the unrolled paint film piece is extended over the treatment surface of the workpiece and pair of left side corner clamps are selectively moveable from a first vertical position above the workpiece, to a second vertical position below the first vertical position to move the adherence surface of the unrolled paint film piece into contact with the treatment surface of the workpiece,
a pair of right side corner clamps, wherein a first one of the pair of right side corner clamps is located at a front corner of the unrolled paint film piece and a second one of the pair of right side corner clamps is located at a rear corner of the unrolled paint film piece, wherein the pair of right side corner clamps are configured to releasably hold a portion of a right side of the unrolled paint film piece as the automated cutting device cuts separates the unrolled paint film piece from the roll of film, wherein the unrolled paint film piece is extended over the treatment surface of the workpiece and pair of right side corner clamps are selectively moveable from a first vertical position above the workpiece, to a second vertical position below the first vertical position to move the adherence surface of the unrolled paint film piece into contact with the treatment surface of the workpiece,
a finished surface spraying device sprays the finished surface of the unrolled paint film piece with liquid,
a robot having a squeegee tool engages and moves the squeegee tool across the finished surface with a plurality of strokes until a desired portion of the finished surface has been squeegeed.

13. The multi-phase paint film application system of claim 12, wherein the liquid applied by the wetting device of the workpiece preparation phase is a gel material having water, alcohol and a surfactant.

14. The multi-phase paint film application system of claim 12, wherein the wetting device of the workpiece preparation phase is a roller connected to a robot, wherein liquid is sprayed onto the roller from a nozzle on the robot.

15. The multi-phase paint film application system of claim 12, wherein the finished surface spray devices sprays the finished surface of the unrolled paint film piece with liquid using a spray nozzle connected to the robot adjacent the squeegee.

16. The multi-phase paint film application system of claim 12, wherein the paint film application arrangement sprays finished surface of the unrolled paint film piece using a spray halo where the workpiece with the unrolled paint film piece is moved through the spray halo and the liquid is applied to the finished surface.

17. The multi-phase paint film application system of claim 12, wherein the squeegee has an edge with two opposing flexible ends with a stiff portion between the two flexible ends.

18. The multi-phase paint film application system of claim 12 further comprising a trim and inspection phase wherein a robotic arm with a trimming tool removes any excess unrolled paint film material from the finished surface and cameras mounted to a robot are used to inspect the finished surface of the paint film piece on the workpiece to determine if there are any defects.

19. The multi-phase paint film application system of claim 12, wherein the wetting device of the workpiece preparation phase is a spray halo where the workpiece is moved through the spray halo and the liquid is applied to the treatment surface of the workpiece.

20. A paint film application arrangement comprising:
an automated cutting device configured to separate the unrolled paint film piece from the roll of paint film;
a plurality of clamps for grasping and holding during the operation of the cutting device, the plurality of clamps also hold the unrolled paint film sheet at a distance from the treatment surface of the at least one workpiece, wherein once the unrolled paint film piece has been separated from the roll of paint film the plurality of clamps move the adherence surface of the unrolled paint film piece into contact with the treatment surface of the workpiece;
a finished surface spraying device sprays the finished surface of the unrolled paint film piece with liquid, and
a robot having a squeegee tool engages and moves the squeegee tool across the finished surface with a plurality of strokes until a desired portion of the finished surface has been squeegeed.

21. The paint film application arrangement of claim 20, wherein the plurality of clamps further include:
at least one forward end clamp, wherein a forward end of the roll of film is held by the at least one forward end clamp and is moveable between a first longitudinal position and a second longitudinal position to form the unrolled paint film piece and extend the unrolled paint film piece over the treatment surface of the workpiece;
at least one left side clamp configured to releasably hold a portion of a left side of the unrolled paint film piece as the automated cutting device cuts separates the unrolled paint film piece from the roll of film, wherein the unrolled paint film piece is extended over the treatment surface of the workpiece and the at least one left side clamp is selectively moveable from a first vertical position above the workpiece, to a second vertical position below the first vertical position to move the adherence surface of the unrolled paint film piece into contact with the treatment surface of the workpiece, and
at least one right side clamp configured to releasably hold a portion of a right side of the unrolled paint film piece as the automated cutting device cuts separates the unrolled paint film piece from the roll of film, wherein the unrolled paint film piece is extended over the workpiece and the at least one right side clamp is selectively moveable from a first vertical position above the workpiece, to a second vertical position below the first vertical position.

22. The paint film application arrangement of claim 20, wherein the plurality of clamps further include:
at least one forward end clamp, wherein a forward end of the roll of film is held by the at least one forward end clamp and is moveable between a first longitudinal position and a second longitudinal position to form the unrolled paint film piece and extend the unrolled paint film piece over the treatment surface of the workpiece;
a pair of left side corner clamps, wherein a first one of the pair of left side corner clamps is located at a front corner of the unrolled paint film piece and a second one of the pair of left side corner clamps is located at a rear corner of the unrolled paint film piece, wherein the pair of left side corner clamps are configured to releasably hold a portion of a left side of the unrolled paint film piece as the automated cutting device cuts separates the unrolled paint film piece from the roll of film, wherein the unrolled paint film piece is extended over the treatment surface of the workpiece and pair of left side corner clamps are selectively moveable from a first vertical position above the workpiece, to a second vertical position below the first vertical position to move the adherence surface of the unrolled paint film piece into contact with the treatment surface of the workpiece, and
a pair of right side corner clamps, wherein a first one of the pair of right side corner clamps is located at a front corner of the unrolled paint film piece and a second one of the pair of right side corner clamps is located at a rear corner of the unrolled paint film piece, wherein the pair of right side corner clamps are configured to releasably hold a portion of a right side of the unrolled paint film piece as the automated cutting device cuts separates the unrolled paint film piece from the roll of film, wherein the unrolled paint film piece is extended over the treatment surface of the workpiece and pair of right side corner clamps are selectively moveable from a first vertical position above the workpiece, to a second vertical position below the first vertical position to move the adherence surface of the unrolled paint film piece into contact with the treatment surface of the workpiece.

23. The paint film application arrangement of claim 20, wherein the finished surface spray devices sprays the finished surface of the unrolled paint film piece with liquid using a spray nozzle connected to the robot adjacent the squeegee.

24. The paint film application arrangement of claim 20, wherein the paint film application arrangement sprays finished surface of the unrolled paint film piece using a spray halo where the workpiece with the unrolled paint film piece is moved through the spray halo and the liquid is applied to the finished surface.

25. The paint film application arrangement of claim 20, wherein the squeegee has an edge with two opposing flexible ends with a stiff portion between the two flexible ends.
